(19) United States
(12) Patent Application Publication
(10) Pub. No.: US 2003/0117699 A1
(43) Pub. Date: Jun. 26, 2003

(54) Use of photonic band gap structures in optical amplifiers

(76) Inventors: Andrew V. Maroney, Epping (GB); Andrew L. Reynolds, Epping (GB)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/032,420

(22) Filed: Dec. 21, 2001

(51) Int. Cl. H01S 3/00

(52) U.S. Cl. 359/342

(57) ABSTRACT

An optical amplifier uses a photonic band gap structure having a doped core defining at least a first wavelength range over which stimulated emission can occur after excitation caused by the introduction of pump light. The photonic band gap structure is designed to permit light having energy corresponding to the wavelength range to be transmitted only in selected directions, including along the photonic band gap structure. The propagation down the structure is one of a discrete number of possible transmission directions for the photons resulting from stimulated emission. This improves the pump efficiency, as the stimulated emissions are concentrated into the direction of propagation down the fiber.

### FIELD OF THE INVENTION

This invention relates to optical amplifiers for example for use in optical communications systems, and more particularly to optical amplifiers which make use of photonic band gap structures.

### BACKGROUND OF THE INVENTION

Large capacity optical transmission systems typically combine high speed signals on a signal fiber by means of Wavelength Division Multiplexing (WDM) to fill the available bandwidth. In these WDM optical transmission systems, in general, rare-earth doped fiber optical amplifiers (such as Erbium or Erbium-Ytterbium doped) are used to compensate for the fiber link and splitting losses. Such amplifiers are provided with laser pump light to cause the optical amplification.

The pump light causes the rare-earth doped atoms to be excited, and a signal in the amplifier can then cause stimulated emission of photons from the excited dopant atoms at the frequency of the signal, causing signal amplification. There is also, however, spontaneous emission from these excited atoms in the same wavelength range (corresponding to a transition from the excited state to the unexcited state), and this spontaneous emission is a source of noise within the amplifier.

There has been a significant amount of research into periodically patterned materials, known as photonic crystals or photonic band gap materials, for applications in the optical domain.

Periodic one-dimensional materials are well known in the form of Bragg filters. Photonic band gap materials extend this concept into two and three dimensions. A correctly designed three-dimensional array can result in a complete photonic band gap, such that no allowed modes exist within a material for any (internal) angle of incidence and for any polarisation. Materials also exist that have optical band gaps for all external angles of incidence, these are known as omnidirectional materials. Additionally, the structure can be engineered so that specific wavelengths of light can travel (or be emitted) only in specific directions.

The analysis of photonic band gap materials is derived from the analysis of lattice structures using techniques developed in the field of crystallography.

By way of example, FIG. 1 shows the notation applied to directional vectors in crystallography for face centered cubic lattices.

FIG. 2 shows the band structure for a close packed face centered cubic lattice of air spheres in a silicon background medium. Different propagation directions through the reciprocal space lattice structure are indicated on the x-axis, using crystallography notation. The y-axis provides a normalised frequency range. The graph shows that each direction of propagation through the reciprocal space lattice can only support a finite number of discrete wavelengths. In other words, a specific wavelength can only propagate through the lattice in specific directions. Furthermore, for a small range of normalized frequencies, around 0.8, there are no permitted directions of propagation.

FIG. 3 shows the density of states against the normalised frequency for the same structure as in FIG. 2. Around the normalised frequency of 0.8, there is a photonic band gap where there are no allowed states within that frequency range.

There are many degrees of freedom in the parameters that make photonic band gap structures, such as the lattice type, the materials, propagation directions and the size and type of the features of the lattice. Despite the large number of variables, techniques have been developed enabling the design of photonic band gap materials to enable band gaps to be engineered to the correct wavelength positions. In particular, generic “photonic band gap-maps” have been developed, and once a gap-map has been defined for a particular lattice type, it can be re-applied taking advantage of the scaling properties of Maxwell's equations, to different materials. These photonic band gap-maps relate normalised frequency to a filling factor for a stated lattice type and dielectric matrix.

By way of example, FIG. 4 shows the gap-map for a hexagonal lattice of cylindrical air holes that have been introduced into a dielectric matrix with an assumed dispersionless dielectric constant of εᵣ=13.6.

There has been significant work in recent years providing tools for the analysis and design of photonic band gap materials, and these techniques are now known to those skilled in the art, and will not be discussed in detail in this document.

The use of photonic band gap materials to form micro-structured optical fibers has been proposed. Typically, such fibers have arrays of holes in their structures that strongly influence the optical guidance qualities of the fiber. Whereas the operation of conventional clad optical fibers relies upon total internal reflection, a photonic band gap fiber can have a hollow core, where guidance is attained by a photonic band gap in the cladding, rather than through internal reflection. However, a photonic band gap fiber can still retain a solid core, so that guidance is still achieved by (modified) total internal reflection.

The use of a solid core within the band gap material introduces a localised defect, which may have different properties to the remainder of the band gap material. For example, a localised state can be formed within the core providing transmission resonance at a frequency corresponding to the band gap region of the remainder of the material. Fibers of this type can provide much wider range of single mode operation than conventional fibers.

Whilst a significant amount of work has been done into the use of photonic band gap structures to provide various optical functions, the use of photonic band gap properties within optical amplifiers has not been widely investigated.

### SUMMARY OF THE INVENTION

According to the invention, there is provided an optical amplifier comprising a photonic band gap structure, the structure comprising:

a solid core which is doped with rare-earth dopant atoms;

a cladding layer around the core and having a periodic lattice structure,

wherein the rare-earth doped core defines at least a first wavelength range over which stimulated emission can occur after excitation caused by the introduction of pump light, and wherein the photonic band gap structure is designed to permit light having energy corresponding to the wavelength range to be transmitted only in selected directions,

wherein the selected directions comprise:

a first direction along the photonic band gap structure.

In this optical amplifier design, the propagation down the structure is one of a discrete number of possible transmission directions for the photons resulting from stimulated emission. This improves the pump efficiency, as the stimulated emissions are concentrated into the direction of propagation down the fiber.

The selected directions may comprise at least one second direction, wherein light transmitted along the at least one second direction is able to escape laterally from the photonic band gap structure.

In this way, there are a number of propagation directions for spontaneous emission, in particular so that a large proportion of the spontaneous emissions can escape from the structure. This improves the noise performance of the amplifier. The stimulated emission will be biased towards the allowed propagation direction, because it is stimulated by a signal travelling in the same direction.,

Preferably, the core comprises a glass core doped with Thulium atoms or Erbium atoms and the cladding layer comprises a glass layer with air passageways running along the length of the structure.

In addition to these air channels, localised defects having different refractive index to the refractive index of the glass may be provided along the length of the structure. This gives the three-dimensional band gap structure.

The microstructuring of the fibre need not necessarily be based on air passageways, and could instead be based on another material so long as the index contrast between the materials is sufficient to create a photonic band gap. These other ‘strands’ provided along the length of the structure then may be periodically loaded, either with air or an alternative material such that a three dimensional periodic structure is created.

The first wavelength range may correspond to a particular channel wavelength for amplification by the amplifier, and wherein the photonic band gap structure is designed to prohibit the transmission of light having energy outside the first wavelength range.

In this way, the propagation of spontaneous emission having a wavelength different to the channel wavelength is prevented thereby reducing noise.

The invention also provides a method of amplifying an optical signal using a photonic band gap structure having a rare-earth doped core and a cladding, the method comprising:

introducing a signal to be amplified and a pump signal into the structure;

constraining the photon emissions from the rare-earth atoms td take place in a plurality of directions, the directions comprising a first direction along the photonic band gap structure.

Again, the plurality of directions, other than the first direction, may each be towards the cladding such that the emissions can escape from the structure.

### BRIEF DESCRIPTION OF THE DRAWINGS

Examples of the invention will now be described in detail with reference to the accompanying drawings, in which:

FIG. 1 shows a known annotation for a face centered cubic lattice;

FIG. 2 shows the relationship between frequency and reciprocal space propagation directions in an example of a close packed face centered cubic lattice of air spheres in a silicon background medium;

FIG. 3 shows the density of states diagram for the structure of FIG. 2;

FIG. 4 is an example of a so-called band gap-map; and

FIG. 5 shows an amplifier in accordance with the invention;

FIG. 6 is used to explain a further aspect of the invention;

FIG. 7 shows a single plot of the frequency/direction relationship to explain further an aspect of the invention; and

FIG. 8 shows use of the amplifier of the invention in an optical communications network.

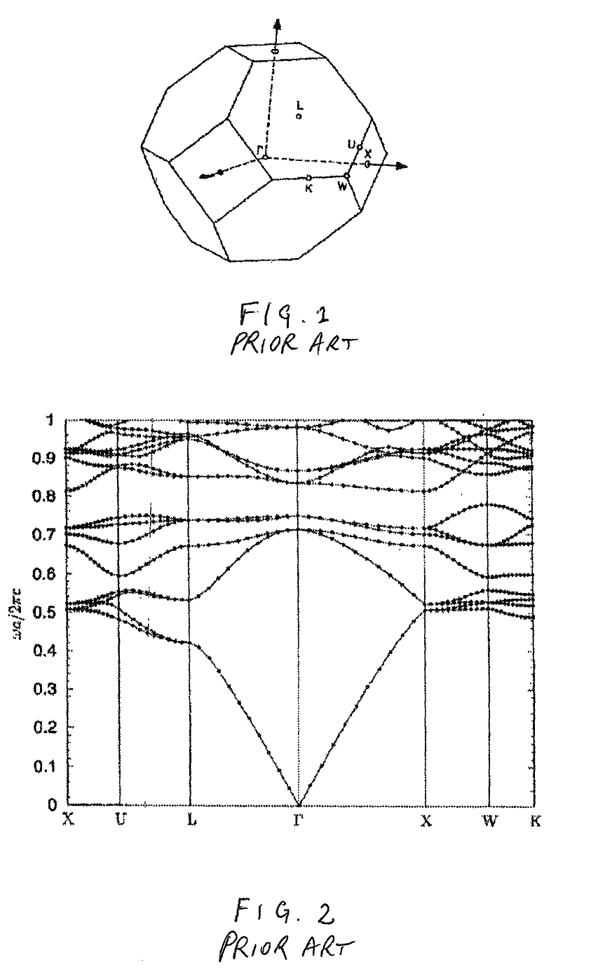

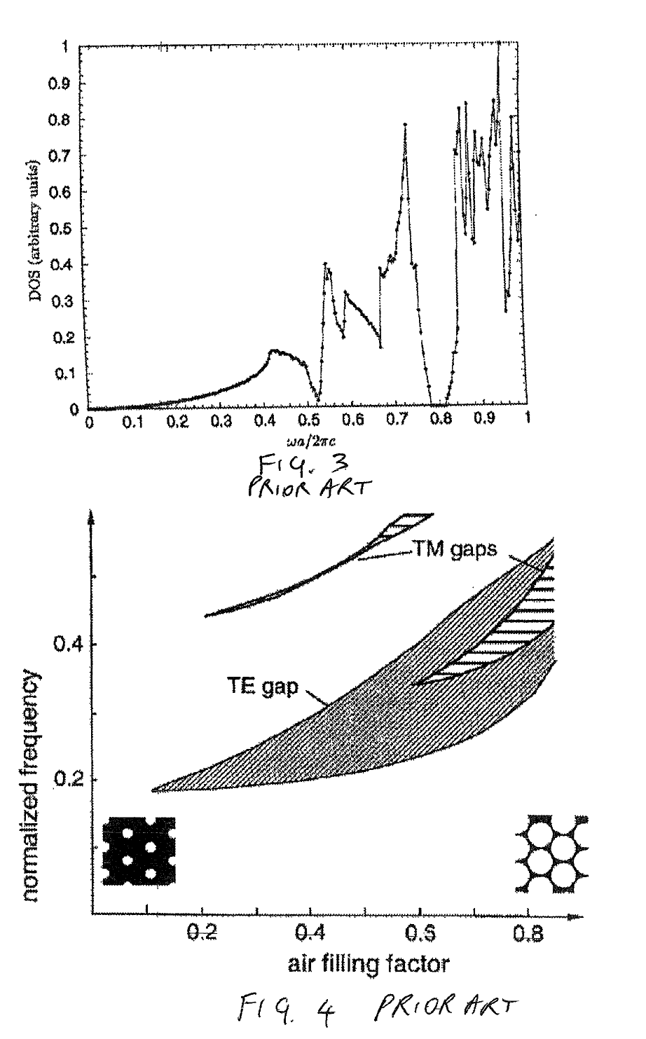

### DETAILED DESCRIPTION OF THE INVENTION

The invention is based on the recognition that the control of permitted propagation directions for specific frequencies within a photonic band gap structure can be applied to improve the performance of rare-earth doped optical amplifiers.

In its most general form, the invention provides a rare-earth doped solid core photonic band gap structure in which light of the signal wavelength can only propagate in discrete directions. One of these directions is the propagation direction along the photonic band gap structure.

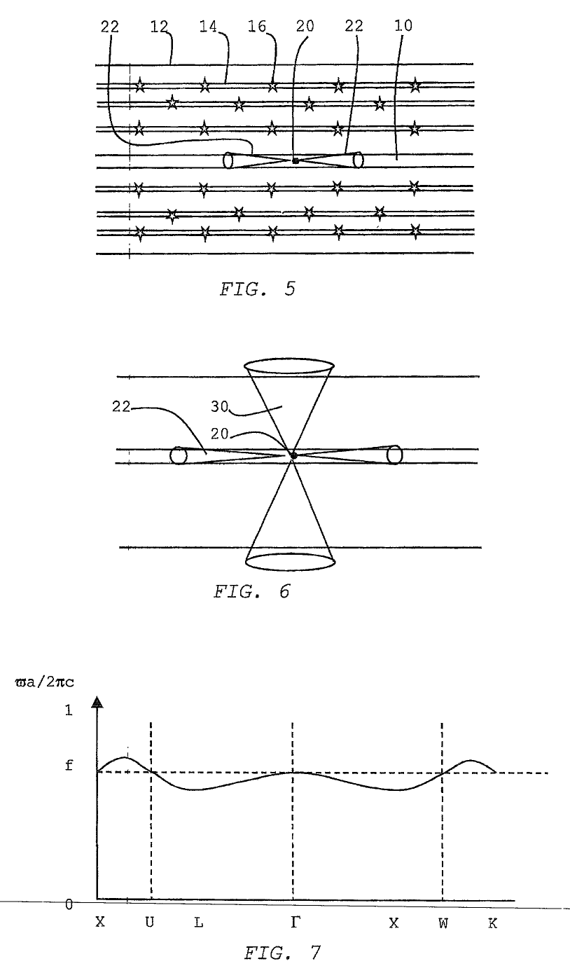

FIG. 5 illustrates this principal. The photonic band gap structure has a solid core 10 which is doped with rare-earth dopant atoms and a cladding layer 12 around the core and having a periodic lattice structure. A signal and pump light are coupled into the structure in conventional manner. The lattice structure includes air passageways 14 (or other material providing a refractive index difference with respect to the main structure of the lattice) running along the length of the structure. This provides a two-dimensional photonic band gap structure, which enables control of the light waveguiding properties in a plane perpendicular to the length of the structure. In order to provide a three-dimensional band gap structure, periodicity is introduced into the continuous strands comprising the two-dimensional photonic band gap structures for example by introducing regions 16 having different refractive index to the refractive index of the glass core along the length of the structure.

The design rules and manufacturing techniques for these structures are now reaching maturity and will not be discussed in this application. There are many patents on the fabrication of photonic crystal fibres, such as U.S. Pat. No. 6,139,626 and U.S. Pat. No. 6,064,511.

The invention employs a band gap structure in which the directions in which stimulated emission can be generated and propagate are limited. An excited rare-earth dopant atom is represented in FIG. 5 as 20. The permitted directions in which stimulated emission can occur include a narrow band 22 along the length of the structure. This improves pump efficiency, as the generation of stimulated emission is concentrated along the longitudinal axis of the structure.

The spontaneous emission from excited dopant atoms will fall in the same wavelength range as the signal to be amplified, so that noise generated from spontaneous emission will the controlled in the same manner, and thus concentrated along the fiber.

In order to reduce noise from spontaneous emission, the invention also provides additional allowed propagation directions for light having the wavelength of the spontaneous emission. FIG. 6 illustrates this concept, in which radiation from the excited atom 22 can propagate in the directions 22 or in a range of directions 30 along which light is able to escape laterally from the photonic band gap structure.

FIG. 7 illustrates schematically how this can be achieved in a photonic band gap structure by ensuring that a specific frequency having normalised frequency f has three specific permitted directions of propagation through the lattice (or bands of permitted directions of propagation). In this example, the directions U and W correspond to the regions 30 in FIG. 6 and the direction Γ corresponds to propagation down the photonic band gap structure.

Despite the possible propagation directions 30, the stimulated emission will follow the path down the fiber, whereas the spontaneous emission will propagate in a random direction. Therefore, by selection of the ranges of permitted directions, the majority of the spontaneous emission energy can be directed out of the band gap structure in the directions 30, which can escape through the cladding.

In a further development, the photonic band gap structure can be designed to prohibit the transmission of light outside the specific channel frequencies, so that the generation of spontaneous emission is inhibited.

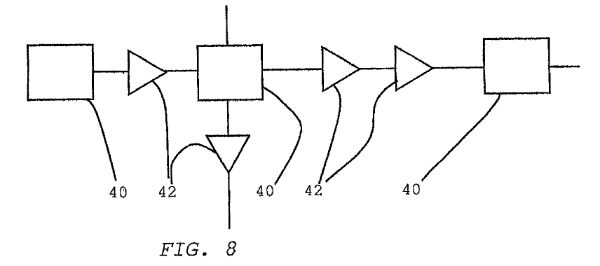

The amplifier of the invention can be used in any situation where a conventional optical amplifier could be used. For example, FIG. 8 shows an optical network comprising nodes 40 connected together by optical fiber spans. The spans may include intermediate optical amplifiers 42. The amplifiers 42 may comprise amplifiers of the invention, and amplification in the nodes may also be performed using amplifiers of the invention.

The invention can be applied to Thulium or Erbium or other rare-earth doped glass core photonic structures.

We claim:

1. An optical amplifier comprising a photonic band gap structure, the structure comprising:
a solid core which is doped with rare-earth dopant atoms;
a cladding layer around the core and having a periodic lattice structure,
wherein the rare-earth doped core defines at least a first wavelength range over which stimulated emission can occurs after excitation caused by the introduction of pump light, and wherein the photonic band gap structure is designed to permit light having energy corresponding to the wavelength range to be transmitted only in selected directions,
wherein the selected directions comprise:
a first direction along the photonic band gap structure.

2. An amplifier as claimed in claim 1 wherein the selected directions comprise at least one second direction, wherein light transmitted along the at least one second direction is able to escape laterally from the photonic band gap structure.

3. An amplifier as claimed in claim 1, wherein the core comprises a glass core doped with Thulium atoms.

4. An amplifier as claimed in claim 1, wherein the core comprises a glass core doped with erbium atoms.

5. An amplifier as claimed in claim 1, wherein the cladding layer comprises a glass layer with passageways running along the length of the structure of a material of different refractive index to the glass of the cladding layer.

6. An amplifier as claimed in claim 5, wherein the passageways are air passageways.

7. An amplifier as claimed in claim 1, wherein the cladding layer comprises a glass layer with localised defects having different refractive index to the refractive index of the glass along the length of the structure.

8. An amplifier as claimed in claim 1, wherein the first wavelength range corresponds to a channel wavelength for amplification by the amplifier, and wherein the photonic band gap structure is designed to prohibit the transmission of light having energy outside the first wavelength range.

9. A method of amplifying an optical signal using a photonic band gap structure having a rare-earth doped core and a cladding, the method comprising:
introducing a signal to be amplified and a pump signal into the structure;
constraining the photon emissions from the rare-earth atoms to take place in a plurality of directions, the directions comprising a first direction along the photonic band gap structure.

10. A method as claimed in claim 9, wherein the plurality of directions, other than the first direction, are each towards the cladding such that the emissions can escape from the structure.

11. A method as claimed in claim 9, wherein the photon emissions are constrained through suitable design of the photonic band gap structure.

12. An optical communications system comprising an amplifier as claimed in claim 1.

13. An optical communications system as claimed in claim 12 comprising a plurality of nodes interconnected by optical fiber spans, wherein at least one node is provided with the amplifier.

14. An optical communications system as claimed in claim 12 comprising a plurality of nodes interconnected by optical fiber spans, wherein at least one amplifier of claim 1 is provided at a location along at least one of the spans.
